(19) United States
(12) Patent Application Publication
(10) Pub. No.: US 2026/0316459 A1
(43) Pub. Date: Oct. 15, 2026

(54) ADJUSTMENT METHOD FOR INKJET PRINTER, NON-TRANSITORY COMPUTER-READABLE RECORDING MEDIUM, AND PRINTING SYSTEM

(71) Applicant: MIMAKI ENGINEERING CO., LTD., Nagano (JP)

(72) Inventors: Wataru Hioki, Nagano (JP); Yutaro Tanaka, Nagano (JP)

(73) Assignee: MIMAKI ENGINEERING CO., LTD., Nagano (JP)

(21) Appl. No.: 19/482,222

(22) PCT Filed: May 10, 2024
(86) PCT No.: PCT/JP2024/017329

§ 371 Date: Nov. 6, 2025

(30) Foreign Application Priority Data
May 12, 2023 (JP) 2023-079315

(51) Int. Cl. B41J 2/21; B41J 11/00; B41J 25/00; B41J 25/308

(52) U.S. Cl. CPC B41J 2/2135; B41J 11/0095; B41J 25/001; B41J 25/308; B41J 2203/01

(57) ABSTRACT

An adjustment method for performing adjustment to a printing apparatus includes: a pattern printing step of causing the printing apparatus to print a test pattern; an analysis step of performing analysis on a reading result of the test pattern; and an adjustment step of performing adjustment of reflecting a result of the analysis to an operation of the printing apparatus. The printing apparatus includes an inkjet head, a main scanning drive unit, and a head position adjustment unit. In the pattern printing step, a head gap is varied in the plurality of levels to print the test pattern. In the analysis step, a difference in an ink landing position in a main scanning direction that occurs due to a difference in the head gap is detected based on the test pattern. In the adjustment step, adjustment based on the difference in the ink landing position is performed.

### CROSS-REFERENCE TO RELATED APPLICATION

This application is a 371 application of the International PCT application serial no. PCT/JP2024/017329, filed on May 10, 2024, which claims the priority benefits of Japan Patent Application No. 2023-079315, filed on May 12, 2023. The entirety of each of the above-mentioned patent applications is hereby incorporated by reference herein and made a part of this specification.

### Technical Field

The present invention relates to an adjustment method for an inkjet printer, a program, and a printing system.

### Background Art

In recent years, inkjet printers, which are printing apparatuses performing printing using inkjet heads, have been widely used. In addition, conventionally, various methods have been known to perform inspection on inkjet heads (e.g., see Patent Document 1).

### Related Art Documents

### Patent Documents

Patent Document 1: Japanese Patent Application Laid-Open No. 2000-62158

### SUMMARY OF INVENTION

### Problems to be Solved by Invention

To perform printing with normal image quality using an inkjet printer, it is required to accurately eject an ink from nozzles of the inkjet head. To accurately eject the ink from the nozzles, it is required to configure a quantity (ejection amount, dot volume) of the ink ejected from the nozzles to an appropriate amount. The quantity of the ink may be adjusted by changing a voltage of a drive signal supplied to each nozzle of each inkjet head. For example, the quantity of the ink may be measured according to a method using a mass meter to adjust the voltage of the drive signal.

An inkjet head generally has a plurality of nozzles. In addition, in an inkjet printer, a plurality of inkjet heads may be used. If ejection adjustment is performed according to conventional methods for the many nozzles included in the plurality of inkjet heads, extremely much effort and time would be required. In addition, variations are also likely to occur in the result of adjustment due to differences among operators performing the adjustment. Thus, conventionally, it has been desired to perform adjustment to an inkjet printer more easily and appropriately. Accordingly, an objective of the present invention is to provide an adjustment method for an inkjet printer, a program, and a printing system capable of solving the problems described above.

### Means for Solving Problem

Regarding adjustment to an inkjet head, the inventors of the present application have considered performing adjustment focusing on an ejection direction velocity, which is the velocity in the vertical direction from the inkjet head toward a medium. In addition, regarding the ejection direction velocity of the ink, the inventors of the present application have focused on the aspect that an ink landing position in the direction (main scanning direction) in which the inkjet head moves during a main scanning operation of the inkjet head changes according to the ejection direction velocity. In addition, the inventors have considered confirming the status of nozzles by causing the inkjet head to eject the ink with the height of the inkjet head varied in the plurality of levels, and measuring a distance between ink landing positions caused by the difference in height. Then, by actually performing various experiments and the like, the inventors have found that the status of nozzles can be confirmed according to such a method, and that adjustment to the inkjet printer can be performed easily and appropriately using the confirmation results.

Further, the inventors of the present application have found a configuration for obtaining the effects described above through further intensive research, and arrived at the present invention. To solve the problems described above, the present invention is an adjustment method for an inkjet printer performing adjustment to the inkjet printer, and includes: a pattern printing step of causing the inkjet printer to print a predetermined test pattern on a medium; an analysis step of analyzing a result of reading the test pattern printed on the medium; and an adjustment step of performing an adjustment by which a result of the analysis in the analysis step is reflected in an operation of the inkjet printer. The inkjet printer includes: an inkjet head that ejects an ink; a main scanning drive unit that causes the inkjet head to perform a main scanning operation of ejecting the ink while moving in a main scanning direction orthogonal to a vertical direction; and a head position adjustment unit that changes a height of the inkjet head in the vertical direction. In the pattern printing step, the inkjet printer is caused to print the test pattern, varying the height of the inkjet head in the plurality of levels with the head position adjustment unit, so that a head gap, which is a distance between a surface of the medium and a nozzle surface at a lower part of the inkjet head, is varied in the plurality of levels. In the analysis step, a difference in an ink landing position in the main scanning direction that occurs due to a difference in the head gap is detected based on the test pattern. In the adjustment step, the adjustment is performed based on the difference in the ink landing position.

With such a configuration, a status of the inkjet printer can be appropriately detected based on the difference in the ink landing position in the main scanning direction detected using the test pattern. In addition, based on the detected result, adjustment to the inkjet printer can be appropriately performed. The test pattern is an example of a pattern obtained by causing the inkjet head to eject the ink from heights different from each other.

In this configuration, by changing the height of the inkjet head in an interval between at least single main scanning operation among the plurality of main scanning operations performed to print the test pattern, the head position adjustment unit causes the height of the inkjet head to differ during execution of the main scanning operations before and after the change. In addition, the adjustment method for an inkjet printer may further include a pattern reading step of generating a pattern image, which is an image representing the test pattern. In this case, in the pattern reading step, the pattern image is generated by reading the medium on which the test pattern is printed in the pattern printing step with a scanner. Further, in the analysis step, analysis of a result of reading the test pattern is performed by analyzing the pattern image representing the test pattern using a computer. With such a configuration, reading and analysis of the pattern can be appropriately performed. In addition, even if the inkjet printer does not have a function of reading the test pattern, reading of the test pattern can be appropriately performed using, for example, a commercially available scanner or the like.

In this configuration, operations of the pattern reading step and the analysis step may be automatically performed using a computer. Further, an operation of the adjustment step may also be automatically performed using a computer. By automatically performing reading, analysis, etc. of the test pattern, even after shipment of the inkjet printer, the inkjet printer can be caused to print the test pattern in a general printing environment where the inkjet printer is used to perform adjustment to the inkjet printer easily and appropriately. In addition, in the analysis step, by performing analysis according to image processing with a computer and performing adjustment to the inkjet printer based on the result thereof, it becomes possible to prevent variations in the adjustment results that may otherwise occur due to individual differences among operators performing the adjustment. Accordingly, this configuration makes it possible to appropriately prevent variations in printing image quality among individual inkjet printers. With such a configuration, adjustment to the inkjet printer can be performed with high accuracy.

In addition, the inkjet printer of this configuration may further include a sub-scanning drive unit. The sub-scanning drive unit is a drive part that moves the inkjet head in a sub-scanning direction relatively with respect to the medium. The sub-scanning direction is a direction orthogonal to the main scanning direction and the vertical direction. In addition, a pattern including a gap variation pattern, which is a pattern formed with the head gap varied in the plurality of levels, may be used as the test pattern. A pattern including a first pattern and a second pattern formed with positions in the sub-scanning direction shifted from each other may be used as the gap variation pattern. The first pattern may be a pattern formed with the ink ejected by the inkjet head at a timing at which the inkjet head moving in the main scanning operation reaches a predetermined position in the main scanning direction, with the head gap configured to be a first height. The second pattern may be a pattern drawn with the ink ejected by the inkjet head at a timing at which the inkjet head moving in the main scanning operation reaches the predetermined position, with the head gap configured to be a second height different from the first height. In this case, in the analysis step, a positional shift of the first pattern and the second pattern in the main scanning direction is detected. In the adjustment step, the adjustment is performed based on the positional shift. With such a configuration, the difference in the ink landing position in the main scanning direction that occurs due to the difference in the head gap can be appropriately detected. Accordingly, adjustment to the inkjet printer can be appropriately performed.

In addition, in this configuration, the difference in the ink landing position in the main scanning direction caused by the difference in the head gap reflects a variation in the velocity in an ejection direction. Further, the ejection direction velocity changes according to a quantity of the ink (quantity of droplet of the ink). The difference in the ink landing position detected in the analysis step corresponds to the quantity of the ink. Thus, in the adjustment step, adjustment of changing the quantity of the ink ejected from a nozzle may be performed based on a result of the analysis in the analysis step. Additionally, in the adjustment step, for example, adjustment may be performed by varying a voltage of a drive signal supplied to the inkjet head. In this case, the inkjet printer further includes a drive signal output unit that outputs a drive signal for driving the inkjet head. In the adjustment step, the voltage of the drive signal supplied to the inkjet head is adjusted based on the difference in the ink landing position. With such a configuration, adjustment to the inkjet printer can be appropriately performed.

In addition, in the case of using the test pattern including the gap variation pattern, as described above, in the analysis step, the positional shift of the first pattern and the second pattern in the main scanning direction is detected. Then, the voltage of the drive signal is changed according to the result of comparing a reference value set in advance with the difference, in the adjustment step. With such a configuration, adjustment to the drive signal can be performed appropriately. It is also contemplated that the reference distance described above may be a value corresponding to the positional shift that should be detected when quantity of the ink is within an appropriate range. The positional shift corresponding to the reference value is a distance between a reference position of the first pattern and a reference position of the second pattern in the case of the appropriate quantity of the ink. Further, this distance may be considered as a target distance that should be achieved in the adjustment of the adjustment step. In the adjustment step, adjustment to the inkjet printer may be performed by calculating an adjustment value or a correction value for matching the positional shift between the first pattern and the second pattern to the target distance, and reflecting the calculated value to the control on the inkjet printer.

In addition, the adjustment to the drive signal is preferably performed individually for each nozzle in the inkjet head. The inkjet head has a plurality of nozzles. The drive signal output unit supplies a drive signal to the inkjet head for each nozzle. Further, the gap variation pattern in the test pattern includes the first pattern and the second pattern enabling detecting the positional shift described above for each nozzle. Then, the positional shift is detected for each nozzle based on such the test pattern in the analysis step. In addition, in the adjustment step, adjustment to the voltage is performed on the drive signal of each nozzle based on the positional shift of each nozzle. With such a configuration, adjustment to the drive signal of each nozzle can be appropriately performed.

Moreover, in the adjustment step, adjustments other than the voltage of the drive signal may also be performed. For example, adjustment to the inkjet printer may be performed by performing image processing based on the analysis result of the analysis step on an image to be printed by the inkjet printer. Specifically, image processing may be performed on a printing image supplied to the inkjet printer as an image to be printed, based on the difference in the ink landing position detected in the analysis step. With such a configuration as well, adjustment to the inkjet printer can be appropriately performed based on the result of analysis in the analysis step. Further, in the analysis step, a deviation amount in the quantity of the ink from the reference quantity may be detected, and image processing may be performed on the printing image to reduce the variation in image quality that occurs according to the deviation amount.

In addition, in this configuration, the head gap may also be thought to change according to a thickness of the medium. Accordingly, in the analysis step, the thickness of the medium may also be detected based on the difference in the ink landing position. In the adjustment step, adjustment based on the thickness of the medium may be performed. With such a configuration as well, adjustment to the inkjet printer can be appropriately performed. Further, adjustment to the height of the inkjet head and the like may be performed as the adjustment based on the thickness of the medium. In addition, when the test pattern including the gap variation pattern described above is used, in the analysis step, at least one of misting of the ink ejected by the inkjet head and curved flight of ink droplets may also be further detected based on the first pattern and the second pattern. With such a configuration, diverse information can be appropriately obtained based on one test pattern.

In addition, a program or a printing system having the same features as described above may also be used as the configuration of the present invention. In these cases as well, the same effects as described above can be obtained.

### Effects of Invention

According to the present invention, adjustment to an inkjet printer can be performed easily and appropriately.

### BRIEF DESCRIPTION OF THE DRAWINGS

FIG. 1A and FIG. 1B are views illustrating a printing system 10 that executes an adjustment method for an inkjet printer according to an embodiment of the present invention. FIG. 1A shows an example configuration of essential components of the printing system 10. FIG. 1B shows an example configuration of essential components of a printing apparatus 12.

FIG. 2A and FIG. 2B are views illustrating a specific configuration of a head unit 102. FIG. 2A shows an example of a configuration of the head unit 102. FIG. 2B shows an example of a configuration of an inkjet head 202 in the head unit 102.

FIG. 3 is a view showing an example of a configuration of an image analysis tool.

FIG. 4A and FIG. 4B are views illustrating an example of analysis executed in an image analysis device 16. FIG. 4A schematically represents a relationship between an ejection direction velocity of an ink and an ink landing position. FIG. 4B shows an example of printing conditions during printing of an adjustment pattern.

FIG. 5A and FIG. 5B are views illustrating an example of an adjustment pattern used in the present embodiment. FIG. 5A shows an example of an arrangement of ink dots 402 formed by single main scanning operation, regarding a gap variation pattern 410 printed as at least a part of the adjustment pattern. FIG. 5B shows an example configuration of the gap variation pattern 410.

FIG. 6 is a flowchart representing an example of operations of the printing system 10.

FIG. 7 is a flowchart representing an example of an operation for calculating a correction value.

### EMBODIMENTS FOR IMPLEMENTING INVENTION

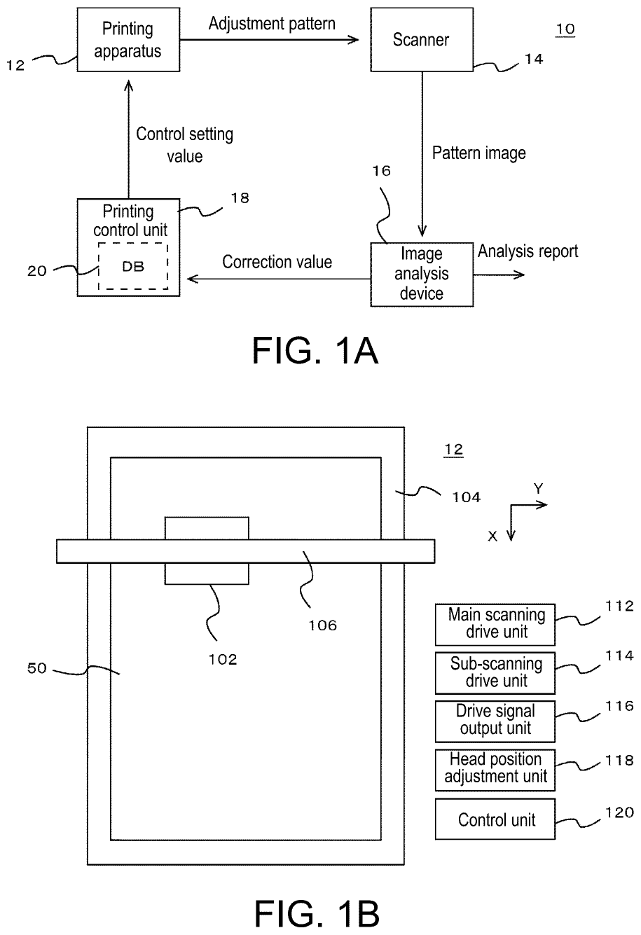

Hereinafter, embodiments according to the present invention will be described with reference to the figures. FIG. 1A and FIG. 1B are views illustrating a printing system 10 that executes an adjustment method of an inkjet printer according to an embodiment of the present invention. FIG. 1A shows an example configuration of essential components of the printing system 10. Except for the aspects described below, the printing system 10 may have the same or similar features as conventional printing systems. For example, the printing system 10 may further have the same or similar configuration as conventional printing systems in addition to the illustrated configuration.

The printing system 10 of the present embodiment is a printing system that performs printing using an inkjet technique, and includes a printing apparatus 12, a scanner 14, an image analysis device 16, and a printing control unit 18. The printing apparatus 12 is an inkjet printer that executes printing in the printing system 10. Furthermore, the printing apparatus 12 of the present embodiment has a plurality of inkjet heads, and prints an adjustment pattern, which is a predetermined test pattern, on a medium serving as a printing target, during adjustment to the printing apparatus 12. The configuration of the printing apparatus 12 will be described in more detail later.

The scanner 14 is an image reading device that reads an image printed on the medium by the printing apparatus 12. The scanner 14 of the present embodiment reads the adjustment pattern printed on the medium during adjustment to the printing apparatus 12. By reading the adjustment pattern using the scanner 14, reading of the adjustment pattern can be easily and appropriately performed without providing the printing apparatus 12 with a specific configuration or the like for reading an image. Furthermore, by using the scanner 14, it also becomes possible to easily and appropriately perform reading of an image at high resolution. The scanner 14 is preferably a color scanner capable of reading an image in full color. In addition, for example, a scanner that is connected to a computer and performs reading of an image according to control of the computer may be used as the scanner 14. Such a scanner 14 may suitably be, for example, a scanner or the like with a maximum readable document size being an A4 size or smaller. In this case, it is preferable to use a scanner with a reading resolution of 2400 dpi or higher (e.g., about 2400 to 4800 dpi, preferably, about 2400 to 3000 dpi). With such a configuration, reading of the adjustment pattern can be appropriately executed using a commercially available, inexpensive scanner for PC or the like. The computer to which the scanner 14 is connected may suitably be a general-purpose PC or the like. In the present embodiment, the image analysis device 16 is used as this computer.

The image analysis device 16 is a computer that performs image analysis on a pattern image, which is an image representing the adjustment pattern, and performs image processing on a pattern image generated by reading of the adjustment pattern with the scanner 14. Accordingly, this configuration allows the image analysis device 16 to perform tasks such as calculating correction values used for an operation control of the printing apparatus 12, and computing numerical values indicating a status of the inkjet head of the printing apparatus 12. In the present embodiment, image analysis device 16 is a computer such as a PC, and calculates numerical values such as a predetermined correction value based on the adjustment pattern according to an image analysis tool, which is a program causing a computer to function as an image analysis device. In addition, the image analysis device 16 supplies the calculated correction value to the printing control unit 18. Furthermore, in the present embodiment, the image analysis device 16 generates an analysis result file, which is a file representing an analysis result, as an analysis report representing a result of analysis in the image processing. The numerical values calculated in the image analysis device 16 and its operation will be described in more detail later.

The printing control unit 18 is a computer (control PC) that controls the operation of the printing apparatus 12, and controls the operation of the printing apparatus 12 in accordance with a program. The printing control unit 18 manages a database 20 that stores control setting values, and controls the operation of the printing apparatus 12 based on the control setting values stored by the database 20. The control setting value is an example of a setting value for controlling the operation of the printing apparatus 12. In addition, the database 20 of the present embodiment is an example of a setting value storage unit that stores control setting values, and is configured as a part of the printing control unit 18. The control setting values stored by the database 20 are stored in a storage device (such as an HDD and an SSD) of the printing control unit 18. Furthermore, in the present embodiment, the database 20 stores a plurality of types of control setting values that are respectively associated with operations different from each other in the printing apparatus 12. In a modification example of the printing control unit 18 and the database 20, the database 20 may be placed outside the printing control unit 18. In addition, the printing control unit 18 of the present embodiment causes the database 20 to store correction value received from the image analysis device 16 as at least a part of the control setting values. Accordingly, the printing control unit 18 controls the operation of the printing apparatus 12 utilizing the correction value calculated by the image analysis device 16. According to such a configuration, it becomes possible to appropriately adjust the operation of the printing apparatus 12 based on the correction value calculated from the adjustment pattern.

Next, the configuration of the printing apparatus 12 in the present embodiment will be described in more detail. FIG. 1B shows an example configuration of essential components of the printing apparatus 12. Except for the aspects described above and below, the printing apparatus 12 may have the same or similar features as conventional printing apparatuses. For example, the printing apparatus 12 may further have the same or similar configuration as conventional printing apparatuses in addition to the illustrated configuration. The printing apparatus 12 of the present embodiment includes a head unit 102, a base unit 104, a Y-bar unit 106, a main scanning drive unit 112, a sub-scanning drive unit 114, a drive signal output unit 116, a head position adjustment unit 118, and a control unit 120. The head unit 102 is a part that ejects an ink to a medium 50 serving as a printing target. In addition, the head unit 102 of the present embodiment includes a plurality of inkjet heads, and ejects the ink from the respective inkjet heads to ejection positions on the medium 50 that are set according to a print resolution. Each of the inkjet heads ejects the ink onto at least a portion of the ejection positions, which are set according to a print resolution, and are selected based on an image to be printed. The detailed configuration of the head unit 102 will be described in more detail later.

The base unit 104 is a platform-shaped member that supports the medium 50 at a position opposed to the head unit 102. The base unit 104 of the present embodiment is a flatbed-type platform, and as shown in the figure, supports the medium 50 opposed to the head unit 102 by placing the entire medium 50 on the upper surface. The Y-bar unit 106 is a member that extends in a width direction of the medium 50 at a position opposed to the base unit 104 with the medium 50 interposed therebetween, and holds the head unit 102 at a position opposed to the medium 50. The width direction of the medium 50 in the present embodiment is a direction parallel to a predetermined main scanning direction (Y-direction in the figure) in the printing apparatus 12. The main scanning direction is a direction orthogonal to the vertical direction. In addition, the Y-bar unit 106 includes, for example, a guide rail that guides movement of the head unit 102 in the main scanning direction, and guides movement of the head unit 102 in the main scanning direction during a main scanning operation. The main scanning operation is an example of an operation in which the head unit 102 ejects the ink while moving relatively in the main scanning direction with respect to the medium 50.

The main scanning drive unit 112 is a drive unit that causes the head unit 102 to perform the main scanning operation. In the present embodiment, the main scanning drive unit 112 causes the head unit 102 to perform the main scanning operation by moving the head unit 102 along the Y-bar unit 106 while causing each inkjet head of the head unit 102 to eject the ink. The main scanning drive unit 112 supplies drive signals, which are received from the drive signal output unit 116 to the inkjet heads according to control by the control unit 120, and causes each nozzle of each inkjet head to eject the ink according to the image to be printed. The drive signal is an example of a signal that causes each of the plurality of inkjet heads to eject the ink. Furthermore, the drive signal may also be considered as a signal for driving an actuator (a piezoelectric element or the like) that causes the ink to be ejected from the nozzles of the inkjet head.

The sub-scanning drive unit 114 is a drive unit that causes the head unit 102 to perform a sub-scanning operation. The sub-scanning operation is an example of an operation that moves the head unit 102 relatively with respect to the medium 50 in a sub-scanning direction (X-direction in the figure) orthogonal to the main scanning direction and the vertical direction. In addition, the sub-scanning operation may also be considered as an operation that changes the position of the medium 50 opposed to the head unit 102 during the main scanning operation. By causing the head unit 102 to perform a sub-scanning operation in an interval between the main scanning operations, the sub-scanning drive unit 114 changes a region on the medium 50 where the ink is ejected in a next main scanning operation. With such a configuration, the head unit 102 can appropriately perform the main scanning operation for each position on the medium 50. Further, in the present embodiment, the sub-scanning drive unit 114 causes the head unit 102 to perform the sub-scanning operation by moving the Y-bar unit 106 together with the head unit 102 by a predetermined sub-scanning moving distance according to control by the control unit 120, with respect to the base unit 104, which is fixed in position. The sub-scanning moving distance is an example of a moving distance by which the plurality of inkjet heads move relatively with respect to the medium 50 in the sub-scanning operation.

The drive signal output unit 116 is an output unit that supplies drive signals for driving the inkjet heads to the plurality of inkjet heads of the head unit 102. In the present embodiment, the drive signal output unit 116 causes the ink to be ejected from the nozzles in each inkjet head by supplying drive signals to the driving actuator of each inkjet head via the main scanning drive unit 112. Accordingly, the drive signal output unit 116 supplies drive signals to each of the plurality of nozzles in the inkjet head individually. Supplying the drive signal to each nozzle may also be regarded as allowing the adjustment of the drive signal for each nozzle. An example of the adjustment to the drive signal may be adjustment to the voltage of the drive signal. Adjusting the voltage of the drive signal may also be regarded as adjusting the voltage at least a part of timings in the drive signal.

The head position adjustment unit 118 is an adjustment unit that changes the height of the inkjet head in the vertical direction. In the present embodiment, by changing the height of at least a part of the Y-bar unit 106, the head position adjustment unit 118 moves the head unit 102 in the vertical direction to change the height of the inkjet head. The head position adjustment unit 118 changes the height of the inkjet head according to the thickness of the medium 50. Moreover, in the present embodiment, the head position adjustment unit 118 changes the height of the inkjet head during the operation of printing the adjustment pattern. By changing the height of the inkjet head during at least one of the interval between the plurality of main scanning operations performed to print the adjustment pattern, the head position adjustment unit 118 causes the height of the inkjet head to differ during execution of the main scanning operations before and after the change. The operation of changing the height of the inkjet head during printing of the adjustment pattern will be described in more detail later.

The control unit 120 is a part that includes the CPU of the printing apparatus 12, and controls the operation of each part of the printing apparatus 12 according to programs such as firmware of the printing apparatus 12. The control unit 120 may also be considered as a configuration corresponding to a control unit in the printing apparatus 12. Moreover, in the present embodiment, the control unit 120 controls the operation of each part of the printing apparatus 12 based on the control setting values stored in the database 20. Accordingly, the control unit 120 causes each part of the printing apparatus 12 to operate based on the control setting values. The control unit 120, for example, controls the operation of the main scanning drive unit 112 based on the control setting values stored in the database 20. Accordingly, the main scanning drive unit 112 causes the head unit 102 to perform the main scanning operation based on the control setting values. In that case, adjustment to the timing of causing each inkjet head to eject the ink may be performed based on the correction values that the database 20 stores as control setting values. With such a configuration, the head unit 102 can be caused to perform the main scanning with higher accuracy. In addition, the control unit 120 further performs adjustment to the sub-scanning moving distance in the sub-scanning operation based on the correction values that the database 20 stores as control setting values. Accordingly, the head unit 102 can be caused to perform the sub-scanning operation with higher accuracy. In that case, correction values different from the correction values for adjusting the timing of causing the inkjet head to eject the ink may be used as the correction values for adjusting the sub-scanning moving distance. Moreover, in the present embodiment, the control unit 120 further changes the voltage of the drive signal supplied to each nozzle of the inkjet head based on the correction values that the database 20 stores as control setting values. Correction values different from the other correction values for adjustment described above may be used as the correction values for adjusting the voltage of the drive signals.

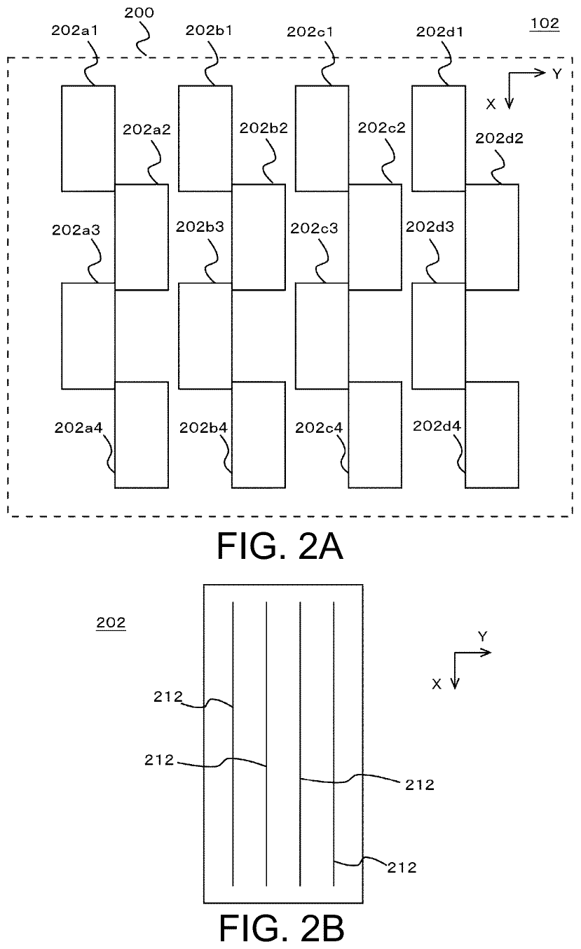

Next, the configuration of the head unit 102 in the printing apparatus 12 will be described in more detail. FIG. 2A and FIG. 2B are views illustrating a specific configuration of the head unit 102. FIG. 2A shows an example of the configuration of the head unit 102. FIG. 2B shows an example of a configuration of an inkjet head 202. In the present embodiment, the head unit 102 has a carriage 200 and the plurality of inkjet heads 202. The carriage 200 is a holding member that holds the plurality of inkjet heads 202, and holds the plurality of inkjet heads 202, as distinguished and shown as reference signs 202a1 to d4 in the figure, to be opposed to the base unit 104 (see FIG. 1B). Holding the inkjet heads 202 to be opposed to the base unit 104 may be considered as holding the inkjet heads 202 such that the ink is ejected toward the medium on the base unit 104.

In addition, the carriage 200 of the present embodiment holds the plurality of inkjet heads 202 in a configuration in which a plurality of rows each with a plurality of inkjet heads 202 arranged in a staggered arrangement in the sub-scanning direction are arranged in the main scanning direction. In the illustrated configuration, four inkjet heads 202 shown as inkjet heads 202a1 to a4 form a first row arranged in a staggered arrangement. In addition, four inkjet heads 202 shown as inkjet heads 202b1 to b4 form a second row arranged in a staggered arrangement. Four inkjet heads 202 shown as inkjet heads 202c1 to c4 form a third row arranged in a staggered arrangement. Four inkjet heads 202 shown as inkjet heads 202d1 to d 4 form a fourth row arranged in a staggered arrangement. Arranging the plurality of inkjet heads 202 in a staggered arrangement may be considered as arranging, in the sub-scanning direction, the plurality of inkjet heads 202 having positions shifted in the main scanning direction. The plurality of inkjet heads 202 may also be arranged in the sub-scanning direction to be partially overlap in the sub-scanning direction. For example, as shown in the figure, in the present embodiment, the four inkjet heads 202 arranged in a staggered arrangement are arranged in the sub-scanning direction to partially overlap in the sub-scanning direction between adjacent inkjet heads 202 while alternately shifting positions in the main scanning direction.

In addition, in this case, it becomes possible to use the plurality of inkjet heads 202 arranged in a staggered arrangement as one virtual large inkjet head. More specifically, the nozzles included in the plurality of inkjet heads 202 arranged in a staggered arrangement may be combined to configure one virtual nozzle row. Further, as shown in the figure, in the present embodiment, the first to fourth rows of the inkjet heads 202 are arranged in the main scanning direction with positions aligned in the sub-scanning direction. In this case, virtual nozzle rows corresponding to each staggered arrangement may be arranged in the main scanning direction. Moreover, the plurality of inkjet heads 202 arranged in each staggered arrangement (one staggered arrangement) may eject an ink of the same color, and inkjet heads 202 arranged in staggered arrangements different from each other may eject inks of colors different from each other. In the case where the carriage 200 holds the plurality of inkjet heads 202 divided into first to fourth rows as in the present embodiment, the inkjet heads 202 of each in the first to fourth rows may eject an ink of a respective color of process colors. The process colors respectively correspond to the primary color in the subtractive color mixing method for color representation. An ink of each color of Y (yellow), M (magenta), C (cyan), and K (black) may be used as the ink of the respective color of process colors. By using such inks, color printing with high quality can be performed. In addition, depending on the application of the printing apparatus 12 (see FIG. 1A and FIG. 1B), a part of the plurality of inkjet heads 202 arranged in one staggered arrangement may eject an ink of a color different from other inkjet heads 202 in the same staggered arrangement. With such a configuration, the head unit 102 can eject inks of more colors. Moreover, the inkjet heads 202 of the plurality of staggered arrangements may also eject an ink of the same color.

Further, regarding the configuration of the head unit 102, the number and arrangement of the inkjet heads 202 are not limited to the example illustrated in FIG. 2A, and may be variously modified. In addition, the head unit 102 may further have other configurations according to the ink ejected from the inkjet heads 202. In the case of ejecting an ultraviolet-curable ink from the inkjet heads 202, the head unit 102 may further have an ultraviolet light source and the like.

Further, the inkjet head 202 of the present embodiment has the plurality of nozzle rows 212, for example, as shown in FIG. 2B. The nozzle row 212 is a row in which the plurality of nozzles are arranged with positions shifted in a predetermined nozzle row direction. In addition, the nozzle row direction of the present embodiment is a direction parallel to the sub-scanning direction. The plurality of nozzles of each nozzle row 212 are arranged in the sub-scanning direction at a constant nozzle pitch, with positions aligned in the main scanning direction. Moreover, the plurality of nozzle rows 212 are arranged in the main scanning direction, with positions slightly shifted in the sub-scanning direction. For example, the positions in the sub-scanning direction may be shifted between the nozzle rows 212 by a distance less than the nozzle pitch in one nozzle row 212. With such a configuration, the distance between the nozzles in the sub-scanning direction in one inkjet head 202 (minimum distance between the nozzles in the sub-scanning direction within the inkjet head 202) can be configured to be shorter than the nozzle pitch in one nozzle row 212. Accordingly, it becomes possible to perform high-resolution printing at high speed.

In FIG. 2B, the example of the configuration of the inkjet head 202 is schematically illustrated for the case where the number of nozzle rows 212 in single inkjet head 202 is four rows. The number of nozzle rows 212 in single inkjet head 202 may also be any number other than four rows. In addition, in the case of considering appropriately performing high-resolution printing at high speed, the number of nozzle rows 212 in single inkjet head 202 is preferably four or more rows (e.g., about 4 to 6 rows).

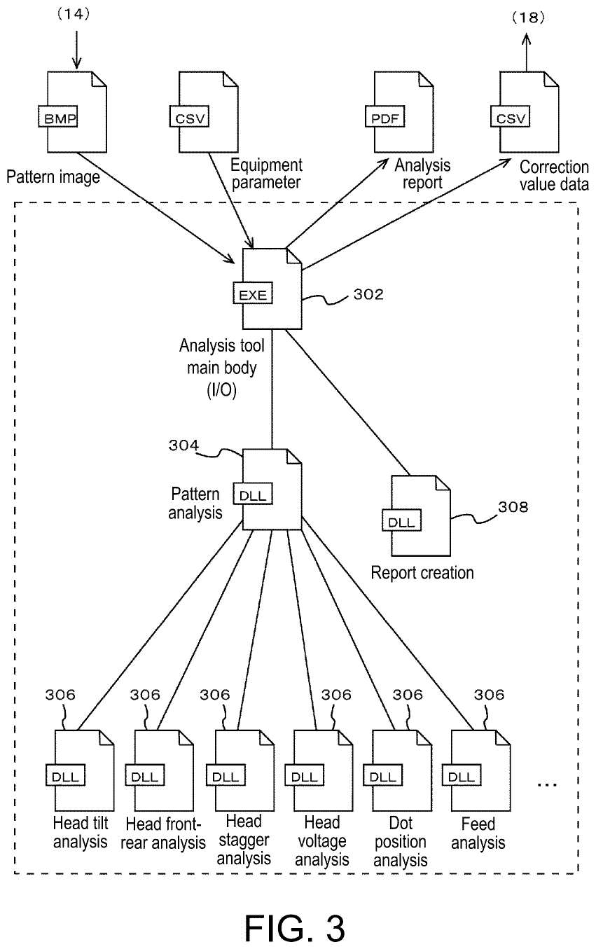

Next, operations of the image processing executed in the image analysis device 16 will be described in more detail. As described above, in the present embodiment, the image analysis device 16 is configured to perform calculation of a numerical value such as a predetermined correction value based on the adjustment pattern according to the image analysis tool. As the image analysis tool, a program having the configuration shown in FIG. 3 is used.

FIG. 3 shows an example of the configuration of the image analysis tool. In the present embodiment, the image analysis tool is a program executed in the image analysis device 16 (see FIG. 1A), and is composed of the plurality of modules. Further, the image analysis tool has, as the plurality of modules, an analysis tool main body 302, a pattern analysis library 304, the plurality of adjustment item libraries 306, and a report generation library 308. The analysis tool main body 302 is a module that serves as a tool main body controlling the entire image analysis tool. Moreover, in the present embodiment, the analysis tool main body 302 is a file in an executable file format (for example, an . exe format file), and performs functions including such as data input/output processing (I/O processing) for the image analysis tool, or management of data input/output processing between modules in the image analysis tool.

In the present embodiment, the analysis tool main body 302 displays a user interface (UI) on a monitor of the image analysis device 16, for example, and performs reading of pattern images and equipment parameters in response to selection of files performed by a user. As described above, the pattern image is an image generated by reading an adjustment pattern printed on a medium with the scanner 14 (see FIG. 1A). The pattern image is stored in the storage device of the image analysis device 16, for example, and is read into the image analysis tool upon being selected by the user via the user interface described above. The pattern image read into the image analysis tool is an example of an analysis image serving as a target of analysis. Further, the equipment parameters are parameters set according to the model of the printing apparatus 12 (see FIG. 1A and FIG. 1B) used for printing the adjustment pattern. By using such model parameters, the image analysis tool can be caused to perform analysis matching the model of the printing apparatus 12. Accordingly, it becomes possible to use a common image analysis tool for printing apparatuses of various model types. For example, parameters indicating the arrangement of inkjet heads in the head unit 102 (see FIG. 2A), the configuration of the inkjet head, etc. may be used as the equipment parameters. As parameters indicating the arrangement of inkjet heads, parameters such as the number of inkjet heads and the number of heads arranged in a staggered arrangement may be used.

In addition, in the present embodiment, the image analysis device 16 outputs correction value data and an analysis report as an output of the operation executed according to the image analysis tool. The image analysis device 16 outputs a file representing correction values calculated by the image analysis device 16 as the correction value data. Further, the image analysis device 16 outputs an analysis result file representing an analysis result as the analysis report. The correction values data may also be considered as a file for feeding back the correction values to the printing apparatus 12. The image analysis device 16 outputs the correction values data by generating a file representing the correction value in a predetermined format. In addition, for example, by executing a program (for example, adjustment tool) that manages information stored by the database 20 with the image analysis device 16 or another computer, the correction values are stored to the database 20. Further, the correction values may be stored directly to the database 20 during operations of the image analysis device 16 executed according to the image analysis tool. For example, a file in a pdf format or a spreadsheet file format may be used as the analysis result file. Further, the analysis report outputted with the analysis result file may be considered as a report that quantifies adjustment levels in the printing apparatus 12 to summarize in a format that is easy for people to understand. In addition, the analysis report may be used for evidence management of adjustment levels and the like.

Each of the pattern analysis library 304, the plurality of adjustment item libraries 306, and the report creation library 308 is a module that functions as a library. In the present embodiment, files in a dynamic link library format (DLL format) are used as modules of these libraries. Further, among these libraries, the pattern analysis library 304 is a library for interpreting the pattern image, and calls required modules from among the plurality of adjustment item libraries 306 based on the result of interpreting the pattern image. Accordingly, the pattern analysis library 304 causes the plurality of adjustment item libraries 306 to perform various analyses on the pattern image. Each of the plurality of adjustment item libraries 306 is a library that performs analysis on various items (adjustment items) serving as targets of analysis by the image analysis tool. In the present embodiment, each of the plurality of adjustment item libraries 306 is a library for items different from each other, and is called from the pattern analysis library 304 as necessary to execute processing related to a corresponding item. Further, in the present embodiment, the image analysis tool is configured to be capable of adding required adjustment item libraries 306, for example, in the case where items to be analyzed increase afterward.

In the present embodiment, as the plurality of adjustment item libraries 306 as shown in the figure, libraries for head tilt analysis, head front-rear analysis, head stagger analysis, head voltage analysis, dot position analysis, and feed analysis are used. In the adjustment item library 306 for head tilt analysis, analysis is performed on a mounting angle of the inkjet head 202 (see FIG. 2A and FIG. 2B) with respect to the carriage 200 (see FIG. 2A). The mounting angle of the inkjet head 202 may also be considered as an angle at which the longitudinal direction of the inkjet head 202 deviates from a predetermined correct orientation. In the adjustment item library 306 for head front-rear analysis, analysis is performed on the position in the front-rear direction, that is, the sub-scanning direction, for each inkjet head 202 held by the carriage 200. In the adjustment item library 306 for head stagger analysis, analysis is performed on the positional relationship in the front-rear direction between adjacent inkjet heads 202 for the plurality of inkjet heads 202 arranged in a staggered arrangement. In the adjustment item library 306 for head voltage analysis, analysis is performed on the voltage of the drive signal supplied to each inkjet head 202. In the adjustment item library 306 for dot position analysis, analysis is performed on the positions of dots formed by the ink ejected from the nozzles of each inkjet head 202. Further, in the adjustment item library 306 for feed analysis, analysis is performed on the sub-scanning movement distance in the sub-scanning operation.

Moreover, in the report generation library 308, an analysis result file is generated based on the results of analyses performed by the plurality of adjustment item libraries 306. The report generation library 308 receives the result of analysis performed by the respective adjustment item library 306 via the analysis tool main body 302 and the pattern analysis library 304. Further, the report generation library 308 outputs the analysis result file via the analysis tool main body 302. In addition, as described above, in the present embodiment, the image analysis device 16 stores the correction value in the database 20 by outputting correction value data. The image analysis device 16 calculates the correction value according to the analysis result of at least a part of the plurality of adjustment item libraries 306. Further, the analysis tool main body 302 receives the correction value from the adjustment item libraries 306 via the pattern analysis library 304, then outputs correction value data indicating the received correction value.

In addition, among the various analyses executed by the plurality of adjustment item libraries 306 in the present embodiment, the head tilt analysis, the head front-rear analysis, and the head stagger analysis are analyses related to mechanical adjustment. In contrast, the head voltage analysis, the dot position analysis, and the feed analysis are analyses related to adjustment (print adjustment) of printing operations other than mechanical adjustment. In the present embodiment, among the adjustment item libraries 306 related to print adjustment, the adjustment item library 306 for dot position analysis and the adjustment item library 306 for feed analysis perform calculation of the correction value. The results of analyses performed by the adjustment item libraries 306 that do not perform calculation of the correction value are reflected in the analysis result file. Further, in the present embodiment, the results of analyses performed by all the adjustment item libraries 306, including the results of analyses performed by the adjustment item libraries 306 that perform calculation of the correction value, are reflected in the analysis result file.

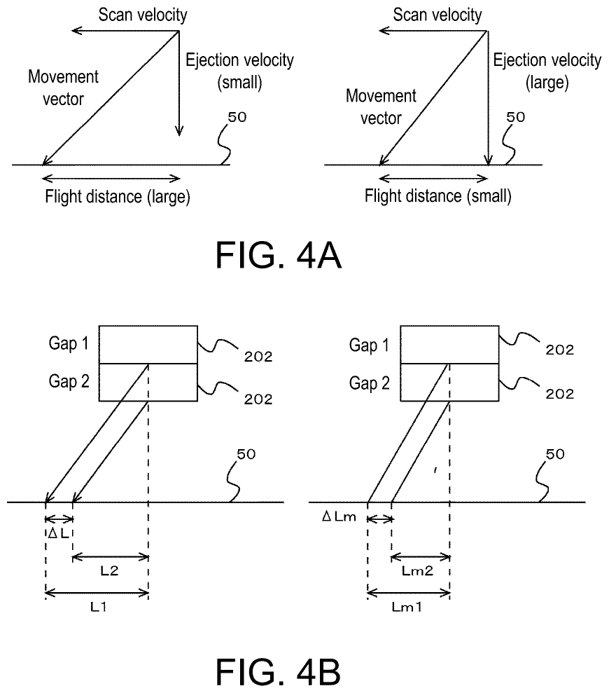

Next, examples of the analyses executed by the adjustment item libraries 306 will be described in more detail. Hereinafter, as an example of the analyses executed by the adjustment item libraries 306, an example of analysis performed by the adjustment item library 306 for dot position analysis will be described. Further, in the image analysis device 16 in present embodiment, analysis of the state of the printing device 12 is performed based on the positions of ink dots formed during printing of the adjustment pattern, using, for example, the matters shown in FIG. 4A and FIG. 4B. In addition, based on the analysis result, calculation of the correction value to be used for adjustment to the printing apparatus 12 is performed.

FIG. 4A and FIG. 4B are views illustrating an example of the analyses executed in the image analysis device 16, and, in relation to an example of the analysis performed by the adjustment item library 306 for dot position analysis, shows an example of the relationship between the status of the printing apparatus 12 related to this analysis and an ink landing position. FIG. 4A schematically shows a relationship between an ejection direction velocity of the ink and the ink landing position.

As described above, in the present embodiment, the inkjet head 202 of the printing apparatus 12 ejects the ink while moving in the main scanning direction according to the main scanning operation. Subsequently, the velocity of the ink (droplet of ink) ejected from the inkjet head 202 is a component that combines a component in the vertical direction (ejection direction) from the inkjet head 202 toward the medium 50 and a component corresponding to the scan velocity, which is the movement speed of the inkjet head 202 during the main scanning operation. As a result, the ink between the inkjet head 202 and the medium 50 gradually approaches the medium 50 while moving in the main scanning direction. Moreover, when a distance by which the droplet moves in the main scanning direction during flight of the ink is defined as a flight distance, and the component in the vertical direction described above is defined as an ejection direction velocity, the flight distance may be thought to change according to the ejection direction velocity. The ejection direction velocity may also be considered as a velocity in the vertical direction from the inkjet head 202 toward the medium 50.

The component in the main scanning direction of the velocity of the ink droplet immediately after being ejected from the nozzle of the inkjet head 202 is a value corresponding to the scan velocity. Further, the ejection direction velocity is a value determined according to the quantity of the ink (volume or quantity of the droplet of the ink). Subsequently, the component in the main scanning direction is a constant value regardless of the properties of the nozzle. In contrast, the quantity of the ink generally changes depending on variations in the properties of the nozzle. Therefore, the ejection direction velocity varies depending on the properties of the nozzle. Then, as schematically shown as a movement vector of the droplet in FIG. 4A, the orientation of movement of the ink flying between the inkjet head 202 and the medium 50 varies according to the ejection direction velocity. As a result, the flight distance varies according to the ejection direction velocity. When the ejection direction velocity is relatively small, the flight distance becomes relatively large. Further, when the ejection direction velocity is relatively large, the flight distance becomes relatively small.

Herein, the velocity of the ink during flight gradually varies due to the influence of factors such as air resistance and gravity. Therefore, the relationship between the ejection direction velocity and the flight distance may be more complex than the relationship shown in FIG. 4A. However, in a configuration that performs printing according to the inkjet method as in the case of the printing apparatus 12 of the present embodiment, the effective ejection direction velocity of the ink during flight may be determined according to the quantity of the ink. Then, the relationship between the effective ejection direction velocity and the flight distance may be considered in the same manner as described above. In this case, based on the correlation between the quantity of the ink and the effective ejection direction velocity, when the quantity of the ink is relatively small, the flight distance becomes relatively large. Further, when the quantity of the ink is relatively large, the flight distance becomes relatively small. Moreover, such a correlation may be considered as a relationship that generally holds in a printing apparatus that performs printing according to the inkjet method. In addition, in the present embodiment, the printing apparatus 12 may also be considered to have a configuration in which such a correlation holds.

Further, the quantity of the ink may also be calculated by measuring the flight distance in principle. However, in the case of a configuration of a general printing apparatus, it is difficult to measure the flight distance. In order to accurately measure the flight distance, it is required to measure the distance in the main scanning direction between the position at which the inkjet head 202 ejects the ink from the nozzle and the position at which the ink lands on the medium 50. Then, the position at which the ink is ejected may be detected as a position in the coordinate system used for control in the main scanning operation. In addition, the ink landing position may be detected as a position in the coordinate system set on the medium 50. However, in that case, since the two coordinate systems are generally different, it is difficult to measure the distance between these positions with high accuracy. Moreover, in order to accurately correlate the positions of two coordinate systems, for example, it becomes required to detect the position on the medium 50 as a position in the coordinate system used for control in the main scanning operation with high accuracy, which increases the cost of the printing apparatus 12.

In contrast, in the present embodiment, as will be described below, instead of directly measuring the flight distance, matters corresponding to a difference in the flight distance are detected based on a difference in the ink landing position (positional shift in the main scanning direction) that occurs in the case of causing conditions during ejection to differ from each other. Then, by adjusting the voltage of the drive signal based on this detection result, the quantity of the ink is adjusted to perform adjustment to the printing apparatus 12. Further, in the present embodiment, for example, as shown in FIG. 4B, the height of the inkjet head 202 is varied in a plurality of levels during printing of the adjustment pattern.

FIG. 4B is a view showing an example of printing conditions during printing of the adjustment pattern, and shows an example of how to print the adjustment pattern serving as the analysis target of the image analysis device 16. As described above, in the printing apparatus 12 of the present embodiment, the height of the inkjet head 202 may be varied by the head position adjustment unit 118 (see FIG. 1B). By varying the height of the inkjet head 202 in the plurality of levels with the head position adjustment unit 118, a head gap, which is the distance between a surface of the medium 50 and a nozzle surface at the lower part of the inkjet head 202, can be changed in the plurality of levels. Then, as the head gap changes by varying the height of the inkjet head 202, the flight distance also changes. This difference in the flight distance may be considered to reflect the difference in the ejection direction velocity. Subsequently, considering that the ejection direction velocity is determined according to the quantity of the ink, the difference in the flight distance may also be thought to be determined according to the quantity of the ink. Further, by actually performing various experiments and the like, the inventors of the present application have confirmed that the difference in the flight distance that occurs by changing the head gap may be correlated with the quantity of the ink.

In addition, regarding this aspect, the figure on the left side of FIG. 4B schematically shows a difference in the flight distance in the case where the quantity of the ink is appropriate. As shown as a gap 1 in the figure, upon configuring the head gap to be a predetermined distance which is relatively large, the flight distance becomes a distance L1. Further, as shown as a gap 2 in the figure, upon configuring the head gap to be another predetermined distance which is relatively small, the flight distance becomes a distance L2. Then, a difference ΔL in the flight distance that occurs by changing the height of the inkjet head 202 becomes equal to a difference (L1−L2) between the distance L1 and the distance L2. This difference ΔL corresponds to the appropriate quantity of the ink.

The figure on the right side of FIG. 4B shows an example of a difference ΔLm in the flight distance in the case where the quantity of the ink is not appropriate. Upon causing the quantity of the ink to deviate from the appropriate quantity, the flight distance changes to a distance different from the distance in the figure on the left side of FIG. 4B. For example, in the figure on the right side, when the head gap is configured to be the same as the gap 1 in the figure on the left side, the flight distance becomes Lm1, which is different from the distance L1. Further, when the head gap is configured to be the same as the gap 2 in the figure on the left side, the flight distance becomes Lm2, which is different from the distance L2. As a result, the difference ΔLm (=Lm1−Lm2) in the flight distance also becomes a value different from the difference ΔL in the case where the quantity of the ink is appropriate. The measured difference ΔLm corresponds to the quantity of the ink.

Herein, as described above, in the present embodiment, the inkjet head 202 ejects the ink from the nozzles according to the drive signals supplied from the drive signal output unit 116 (see FIG. 1B). Then, by changing the voltage of the drive signal, the quantity of the ink ejected from the nozzle can be varied. Therefore, for example, when the quantity of the ink is not the appropriate level, the voltage of the drive signal may be changed to bring the quantity of the ink closer to the appropriate quantity. Then, by changing the voltage of the drive signal based on the difference between the measured difference ΔLm and the difference ΔL in the case where the quantity of the ink is appropriate, the ink can be brought closer to the appropriate quantity.

Further, as described above, in the present embodiment, the image analysis device 16 performs calculation of a numerical value such as a correction value based on the adjustment pattern printed on the medium 50. Regarding the quantity of the ink, the image analysis device 16 calculates a correction value for changing the voltage of the drive signal based on the adjustment pattern including a pattern for measuring the difference ΔLm in the flight distance. In addition, in the printing system 10, adjustment to the printing apparatus 12 is performed by causing the correction value to be stored in the database 20 (see FIG. 1A) by, for example, the image analysis device 16 or the printing control unit 18 (see FIG. 1A). More specifically, taking the difference ΔL in the flight distance in the case of the appropriate quantity of the ink as a target value (target distance), the voltage of the drive signal is varied so as to bring the measured difference ΔLm in the flight distance closer to the target distance. Further, in the present embodiment, the image analysis device 16 calculates the correction value for changing the voltage of the drive signal in this manner based on the adjustment pattern. Bringing the difference ΔLm in the flight distance closer to the target distance may be considered as configuring the difference between ΔLm and the target distance to be a value within a predetermined tolerance range.

Moreover, the image analysis device 16 calculates the correction value for changing the voltage of the drive signal based on a relationship between a voltage variation and a difference in the flight distance prepared in advance. A parameter indicating the difference in the flight distance caused by a voltage variation per unit voltage (for example, 1 V) of the drive signal may be used as the relationship between the voltage variation and the difference in the flight distance. An amount by which the measured difference ΔLm in the flight distance varies per unit voltage may be used as the difference in the flight distance caused by a voltage change per unit voltage. More specifically, taking the difference in the flight distance caused by a voltage variation per unit voltage of the drive signal as A, and taking the voltage adjustment amount for changing the drive signal as dV, the voltage adjustment amount dV may be calculated according to:

dV=(|ΔLm|−ΔL)/A (Calculation Formula 1).

The parameter A may differ depending on the type and color of the ink. Therefore, a value determined in advance according to the type and color of the ink may be used for the parameter A. Further, as described above, an absolute value of distance may be used as |ΔLm| for the measured difference ΔLm in the flight distance. Such adjustment may also be performed in a state where a voltage adjustment value, which serves as a correction value (control setting value) for adjusting the voltage of the drive signal, has already been set. Then, with respect to the voltage adjustment amount dV calculated according to Calculation Formula 1 above, the voltage adjustment amount dV may be added to a current voltage adjustment value according to Calculation Formula 2 below.

(voltage adjustment value after adjustment)=(current voltage adjustment value)+(voltage adjustment amount dV) (Calculation Formula 2)

The current voltage adjustment value corresponds to the correction value before performing adjustment. Further, the voltage adjustment value after adjustment corresponds to the new correction value calculated in the image analysis device 16. More specifically, when the current voltage adjustment value is +1.0 V, the target distance is 100 μm, the unit voltage is 1 V, and the difference A in the flight distance caused by the voltage change per unit voltage of the drive signal is 20 μm, if the measured difference ΔLm in the flight distance is −110 μm, according to Calculation Formula 1, the voltage adjustment amount dV is:

dV=(|−110|−100)/20=+0.5 V.

As a result, the voltage adjustment value after adjustment corresponding to the new correction value becomes +1.5 V according to Calculation Formula 2.

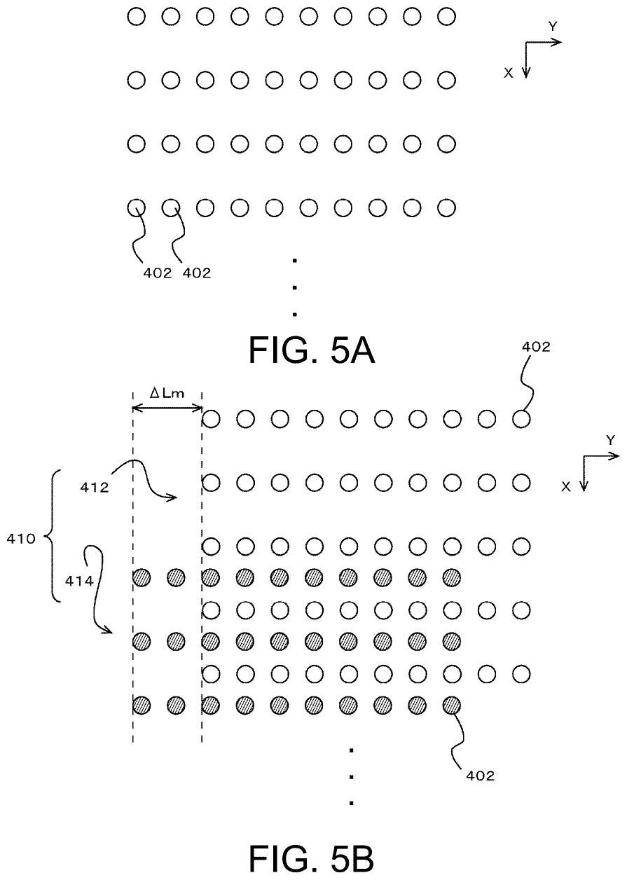

Further, in the present embodiment, when the voltage of the drive signal is adjusted based on the difference ΔLm in the flight distance, a pattern including a gap variation pattern, which is a pattern drawn with the head gap varied in the plurality of levels, is used as the adjustment pattern to be printed by the printing apparatus 12. For example, a pattern shown in FIG. 5A and FIG. 5B may be used as the gap variation pattern. FIG. 5A and FIG. 5B are views illustrating an example of the adjustment pattern used in the present embodiment. FIG. 5A shows an example of an arrangement of the ink dots 402 formed in one main scanning operation in the case of printing a gap variation pattern 410 printed as at least a part of the adjustment pattern for performing the adjustment described with reference to FIG. 4A and FIG. 4B. FIG. 5B shows an example of a configuration of the gap variation pattern 410.

In the present embodiment, the printing apparatus 12 (see FIG. 1A and FIG. 1B) is configured to print the gap variation pattern 410 by performing the plurality of main scanning operation. Then, by varying the height of the inkjet head 202 (see FIG. 2A and FIG. 2B) during at least one of the intervals between a plurality of main scanning operations for printing the gap variation pattern 410, main scanning operations for printing the gap variation pattern 410, the height of the inkjet head 202 during execution of the main scanning operations before and after the variation is varied. Further, in each main scanning operation, by ejecting the ink at predetermined intervals during the main scanning operation with the nozzles serving as adjustment targets of the inkjet head 202, the printing apparatus 12 forms on the medium an arrangement of the ink dots 402 arranged in the main scanning direction, for example, as shown in FIG. 5A. The plurality of ink dots 402 arranged in the main scanning direction with positions aligned in the sub-scanning direction are formed by the same nozzle. Further, in this case as well, the printing apparatus 12 performs the sub-scanning operation in the interval between the main scanning operations, for example, similarly to the case of normal printing. In this case, even for the ink dots 402 formed by the same nozzle, when formed in different main scanning operations, the positions in the sub-scanning direction will be shifted. Therefore, for the ink dots 402 formed by the same nozzle according to the plurality of main scanning operations with different head gaps, it is possible to identify in which main scanning operation the ink dots 402 are formed based on the positions of the ink dots 402 in the sub-scanning direction.

Further, in the present embodiment, the gap variation pattern 410 includes a first pattern 412 and a second pattern 414 that are drawn with positions in the sub-scanning direction shifted from each other, for example, as shown in FIG. 5B. For convenience of illustration, in FIG. 5B, the ink dots 402 included in the first pattern 412 are shown as white circles, and the ink dots 402 included in the second pattern 414 are shown with a hatched pattern. In addition, in the present embodiment, the first pattern 412 is a pattern drawn with the head gap configured to be a first distance. The second pattern 414 is a pattern drawn with the head gap configured to be a second distance different from the first distance. In this case, the first pattern 412 is a pattern drawn with the ink ejected by the inkjet head 202 at a timing when the inkjet head 202 moving in the main scanning operation reaches predetermined positions in the main scanning direction. Further, the printing apparatus 12 selects at least a part of the nozzles of the inkjet head 202 as the nozzles serving as the adjustment targets, and forms the plurality of the ink dots 402 constituting the first pattern 412 on the medium by causing the selected nozzles to eject the ink. The second pattern 414 is a pattern drawn with the ink ejected by the inkjet head 202 at the same timing as the first pattern 412, in a main scanning operation with the head gap caused to differ from that during drawing of the first pattern 412. The ink dots 402 formed during drawing of the second pattern 414 would have the same positions in the main scanning direction as the ink dots 402 of the first pattern 412 if the head gap was configured to be the first distance described above. Moreover, the second pattern 414 may also be considered as a pattern in which the positions in the main scanning direction at which the ink is ejected during the main scanning operation are configured to be the same as those during drawing of the first pattern 412. The second pattern 414 may also be considered as a pattern drawn with the ink ejected at a timing when the inkjet head 202 moving in the main scanning direction reaches the predetermined positions described above during drawing of the first pattern 412.

The positions at which the ink lands differ between the first pattern 412 and the second pattern 414 due to the influence of the difference in the head gap. As a result, a deviation occurs in the positions in the main scanning direction between the first pattern 412 and the second pattern 414. As indicated by broken lines in the figure, by measuring the difference between the position of the first pattern 412 in the main scanning direction and the position of the second pattern 414 in the main scanning direction, the difference ΔLm in the flight distance can be measured.

Herein, in FIG. 5B, for convenience of illustration, an example of the deviation between the first pattern 412 and the second pattern 414 is shown in the case where the ink quantity of all the nozzles of the inkjet head 202 is appropriate. In this case, the measured difference ΔLm in the flight distance becomes equal to the difference ΔL in the case where the quantity of the ink is appropriate. However, when actually drawing the gap variation pattern 410, since the quantity of the ink differs for each nozzle due to variations in nozzle properties and the like, the first pattern 412 and the second pattern 414 deviate in a manner reflecting the quantity of the ink corresponding to individual nozzles. Therefore, in actual measurement of the difference ΔLm in the flight distance, the difference ΔLm in the flight distance may be measured for each arrangement of the ink dots 402 in which the plurality of ink dots 402 are arranged in the main scanning direction. In this case, the first pattern 412 and the second pattern 414 in the gap variation pattern 410 may be considered as patterns enabling detecting the difference ΔLm in the flight distance for each nozzle. With such a configuration, the difference ΔLm in the flight distance can be appropriately measured for each nozzle serving as the adjustment target. Accordingly, in the adjustment to the drive signal performed using the gap variation pattern 410, individual adjustment can be appropriately performed for each nozzle of the inkjet head 202.

Further, the arrangement of the ink dots 402 in the first pattern 412 and the second pattern 414 is preferably formed such that the positions in the sub-scanning direction of the arrangement of the ink dots 402 in the first pattern 412 and the positions in the sub-scanning direction of the arrangement of the ink dots 402 in the second pattern 414 do not overlap with each other, as shown in FIG. 5B, for example. With such a configuration, the arrangement of the ink dots 402 in the first pattern 412 and the arrangement of the dots 402 in the second pattern 414 can be distinguished more easily and appropriately.

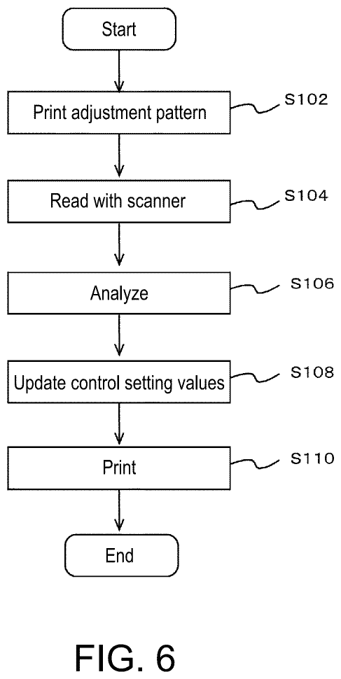

Subsequently, the adjustment and printing operation executed by the printing apparatus 12 in the printing system 10 will be described in more detail with reference to flowcharts. FIG. 6 is a flowchart representing an example of the operations of the printing system 10. As described above, in the case of performing adjustment to the printing apparatus 12 of the printing system 10, the printing apparatus 12 is caused to print an adjustment pattern on a medium (S102). In the present embodiment, the operation of step S102 is an example of an operation of a pattern printing step. The pattern printing step is a step in which the printing apparatus 12 is caused to print a predetermined test pattern on a medium. In step S102 of the present embodiment, the printing apparatus 12 prints the adjustment pattern according to an instruction of the printing control unit 18. The printing control unit 18 causes the printing apparatus 12 to print the adjustment pattern that is dynamically generated according to the configuration of the printing apparatus 12. As such an adjustment pattern, for example, an adjustment pattern generated according to the item of adjustment to be executed may be used. By using such an adjustment pattern, the printing control unit 18 causes the printing apparatus 12 to print the adjustment pattern including a pattern corresponding to the item of adjustment according to the item of adjustment to be executed.

As described with reference to FIG. 4A to FIG. 5B, in the case of performing adjustment to the voltage of the drive signal, the printing control unit 18 causes the printing apparatus 12 to print an adjustment pattern including the gap variation pattern 410. The printing control unit 18 causes the printing apparatus 12 to perform the plurality of main scanning operations with the head gap caused to differ from each other. That is, the printing apparatus 12 is caused to print an adjustment pattern drawn with the head gap varied in the plurality of levels. Further, the printing system 10 may also perform adjustment for the plurality of adjustment items simultaneously. In that case, the printing control unit 18 causes the printing apparatus 12 to print an adjustment pattern including the plurality of types of patterns corresponding to the plurality of adjustment items.

Moreover, the printing apparatus 12 in step S102 prints the adjustment pattern on the medium within a printing range of an A4 size or smaller. With such a configuration, a commercially available, inexpensive scanner for PC or the like may be used as the scanner 14. Further, in the present embodiment, the printing apparatus 12 is configured to print the adjustment pattern on a medium of an A4 size or smaller, which is smaller than a maximum size medium capable of being held by the base unit 104. More specifically, in step S102 of the present embodiment, the printing apparatus 12 is configured to print the adjustment pattern on an A4 size medium. Such an operation may also be considered as an operation of printing the adjustment pattern within a printing range narrower than a printable range of the printing apparatus 12.

Further, as described above, a scanner with a reading resolution of 2400 dpi or higher may be used as the scanner 14. Then, with the size of the adjustment pattern becoming large to, for example, an A3 size or larger, the size of the file generated by reading of the image with the scanner 14 may become extremely large. Therefore, in this aspect as well, the range for printing the adjustment pattern is preferably configured to be the A4 size or smaller. In addition, depending on the type or the number of items of adjustment to be executed, it may be difficult to print all required adjustment patterns on one sheet of the medium of the A4 size or smaller. In such a case, the plurality of sheets of the medium of the A4 size or smaller may be used as necessary. The printing control unit 18 causes the printing apparatus 12 to print the adjustment pattern on each of the plurality of media. In that case, the pattern printed on each medium is a part of the adjustment pattern. With such a configuration, even in the case where all required patterns cannot be printed on one sheet of the A4 size medium, the printing apparatus 12 can be caused to print all required patterns by dividing the patterns among the plurality of media.

Further, after causing the printing apparatus 12 to print the adjustment pattern in step S102, the medium with the adjustment pattern printed thereon is read by the scanner 14 to generate a pattern image representing the adjustment pattern (S104), and perform analysis on the pattern image by the image analysis device 16 (S106). The operation of step S104 in the present embodiment is an example of an operation of a pattern reading step. Reading of the image by the scanner 14 in step S104 may be performed in the same or similar manner as conventionally known methods for reading an image with the scanner 14. In addition, the operation of step S106 in the present embodiment is an example of an operation of an analysis step. The analysis step is a step that performs analysis on the result of reading the test pattern printed on the medium. In step S106 of the present embodiment, the image analysis device 16 executes predetermined image processing and calculations as the analysis on the pattern image. Accordingly, as described above, the image analysis device 16 is configured to calculate a correction value used for controlling operation of the printing apparatus 12, and calculate a numerical value indicating the status of the inkjet head in the printing apparatus 12. Further, the operation of step S106 in the present embodiment is also an example of an operation that causes a computer to perform analysis processing. In that case, the analysis step may be considered as a step that performs analysis on the result of reading the test pattern by analyzing the pattern image with the computer.

In addition, after calculating the correction value and the like in step S106, update of the control setting value stored in the database 20 is performed based on the correction value by the image analysis device 16 or the printing control unit 18 (S108). The operation of step S108 in the present embodiment is an example of operations of a setting value update step and an adjustment step. The setting value update step is a step that updates at least a part of the control setting values based on the result of analysis in the analysis step. Further, the adjustment step may also be considered as a step in which adjustment is performed to reflect the result of analysis of the analysis step to the operation of the printing apparatus 12. The operation of updating at least a part of the control setting values is an example of an adjustment operation for the printing apparatus 12. In step S108 of the present embodiment, the image analysis device 16 outputs correction value data and an analysis result file based on the result of analysis in step S106. Then, as described above, by executing a program that manages information stored by the database 20 with the image analysis device 16 or the printing control unit 18, the correction value is stored to the database 20 based on the correction value data.

In step S108 of the present embodiment, based on the result of analysis in the analysis step, the control setting value for adjusting the voltage of the drive signal corresponding to each nozzle of the inkjet head is changed. Accordingly, the result of analysis in the analysis step is reflected to the operation of the printing apparatus 12. According to the present embodiment, by reading the adjustment pattern with the scanner 14 and executing predetermined image processing and calculations with the image analysis device 16, calculation of the correction value used for adjustment to the printing apparatus 12 can be appropriately performed. Further, by storing the calculated correction value to the database 20, adjustment to the printing apparatus 12 can be performed easily and appropriately.

In addition, in the present embodiment, after the printing system 10 performs adjustment of the printing apparatus 12 as described above, the printing control unit 18 causes the printing apparatus 12 to execute an operation of printing based on the updated control setting values (S110). The operation of printing executed by the printing apparatus 12 in step S110 is an example of an operation of printing for creating a desired printed matter. According to the present embodiment, adjustment to the printing apparatus 12 can be appropriately performed. Further, after performing required adjustment to the printing apparatus 12, a printed matter can be appropriately produced by the printing apparatus 12.

Moreover, as described above, in the present embodiment, reading and analysis of the test pattern, and adjustment based on the analysis result may be automatically performed by the image analysis device 16 and the like, without requiring, for example, subjective judgment of an operator. By analyzing the result of reading the test pattern according to image processing in the image analysis device 16 and performing adjustment to the printing apparatus 12 based on the result thereof, it becomes possible to prevent occurrence of a difference in the result of adjustment due to individual differences or the like among operators who perform the adjustment. Accordingly, regarding printing image quality of each printing apparatus 12, it is possible to prevent a difference for each individual printing apparatus 12. Herein, a difference in image quality of each individual printing apparatus 12 means that a difference occurs in the printing result between printing apparatuses 12 having the same configuration. Moreover, a difference in the printing result between printing apparatuses 12 having the same configuration means that, among the plurality of printing apparatuses 12 using the inkjet head 202 and the ink, which are the same products, a difference occurs in the quantity of the ink (ejection amount) due to the influence of individual differences for each inkjet head 202, and a difference occurs in the color of the printed matter. Furthermore, in the present embodiment, by automatically performing calculation of the correction value and the like, adjustment to the printing apparatus 12 can be performed easily and appropriately even in the case where the number of inkjet heads 202 in the printing apparatus 12 or the number of nozzles in the inkjet head 202 is large. In addition, during adjustment performed for the printing apparatus 12, a part of the work may also be performed by an operator. In that case, the work of adjustment can be semi-automated according to image processing using the image analysis device 16. Further, in that case as well, by semi-automating the work of adjustment, it is possible to reduce the time required for adjustment and the burden on the operator.

In addition, adjustment to the printing apparatus 12 may be performed during manufacturing of the printing apparatus 12. In the present embodiment, by performing the operations described above automatically or semi-automatically, even after shipment of the printing apparatus 12, a test pattern may be printed by the printing apparatus 12 in a general printing environment where the printing apparatus 12 is used, to perform adjustment to the printing apparatus 12 easily and appropriately. Further, even if the printing apparatus 12 does not have a function of reading the test pattern, reading of the test pattern may be appropriately performed using, for example, a commercially available scanner 14. Such post-shipment adjustment may be performed by maintenance personnel dispatched from the manufacturer of the printing apparatus 12 at a site where the printing apparatus 12 is used. Moreover, the post-shipment adjustment may also be performed by the user who owns the printing apparatus 12.

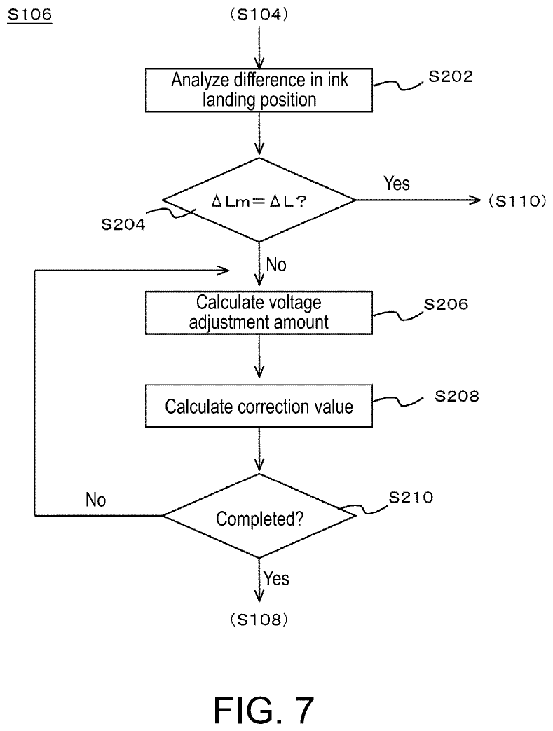

Next, an example of the operation for calculating the correction value in step S106 will be described in more detail. FIG. 7 is a flowchart representing an example of the operation for calculating the correction value in step S106, and shows an example of the operation for calculating the correction value when adjusting the voltage of the drive signal, as described with reference to FIG. 4A to FIG. 5B. By analyzing a pattern image generated by reading the adjustment pattern including the gap variation pattern 410 with the scanner 14, the image analysis device 16 detects positional shift in the main scanning direction between the first pattern 412 and the second pattern 414 in the gap variation pattern 410 (S202). Further, as can be learned from the matters described with reference to FIG. 4A, FIG. 4B, and FIG. 6, this positional shift in the present embodiment corresponds to the difference in the ink landing position in the main scanning direction that occurs due to the difference in the head gap. Moreover, this difference corresponds to a measured value of the difference ΔLm in the flight distance generated according to the variation in the head gap. Therefore, the detection of the positional shift in the main scanning direction between the first pattern 412 and the second pattern 414 corresponds to analyzing the difference in the ink landing position that occurs due to the variation in the head gap.

Further, as described above, in the present embodiment, the first pattern 412 and the second pattern 414 in the gap variation pattern 410 are patterns enabling detecting the difference ΔLm in the flight distance for each nozzle. Therefore, in step S202 of the present embodiment, by detecting the positional shift in the main scanning direction between the first pattern 412 and the second pattern 414 for each nozzle serving as the adjustment target in the inkjet head 202, the image analysis device 16 measures the difference ΔLm in the flight distance for each nozzle. The detection of the positional shift in the main scanning direction between the first pattern 412 and the second pattern 414 for each nozzle means detecting the positional shift in the main scanning direction for each position corresponding to individual nozzles in the first pattern 412 and the second pattern 414. Further, as described above, the difference ΔLm in the flight distance in the present embodiment corresponds to the quantity of the ink. In addition, the quantity of the ink ejected from the nozzles of the inkjet head 202 is capable of being adjusted by changing the voltage of the drive signal. Then, by changing the voltage of the drive signal based on the difference ΔLm in the flight distance, the quantity of the ink can be adjusted. Accordingly, in the present embodiment, the image analysis device 16 performs calculation of the correction value for adjusting the voltage of the drive signal based on the difference ΔLm in the flight distance according to subsequent operations.

The image analysis device 16 is configured to perform confirmation on whether the difference ΔLm in the flight distance for each nozzle measured in step S202 is equal to a target distance ΔL set in advance (S204). The difference ΔLm in the flight distance being equal to the target distance ΔL means that the difference between the two is within a predetermined tolerance range. Then, when the difference ΔLm in the flight distance and the target distance ΔL are equal for all nozzles serving as the adjustment targets (S204, Yes), it is determined that adjustment to the voltage of the drive signal is not required, and the operation of adjustment is ended without calculating a new correction value. Subsequently, the process proceeds to step S110, and the printing apparatus 12 is caused to execute the operation of printing. That is, the operation of step S108 is omitted in the flowchart shown in FIG. 6.

Further, when it is determined in step S204 that the difference ΔLm in the flight distance and the target distance ΔL are not equal for any of the nozzles (S204, No), the image analysis device 16 calculates a voltage adjustment amount dV of the nozzle based on the difference ΔLm in the flight distance measured for the nozzle, for each of all of the nozzles for which the difference ΔLm and the target distance ΔL are determined not to be equal (S206). The image analysis device 16 calculates the voltage adjustment amount dV according to Calculation Formula 1 described with reference to FIG. 4A and FIG. 4B. Further, the image analysis device 16 calculates, for each nozzle, a voltage adjustment value adjusted according to the calculated voltage adjustment amount dV according to Calculation Formula 2 described with reference to FIG. 4A and FIG. 4B, as a correction value corresponding to the difference ΔLm in the flight distance (S208).

Moreover, in the present embodiment, the image analysis device 16 further performs confirmation on completion of adjustment after performing calculation of the correction value in step S208 (S210). In this case, as confirmation on completion of adjustment, whether the quantity of the ink has changed to a target quantity (appropriate quantity) may be confirmed by using the correction value calculated in step S208. More specifically, in the printing system 10, using the correction value after adjustment, the printing apparatus 12 is caused to print the gap variation pattern 410 to confirm that the difference ΔLm in the flight distance measured and the target distance ΔL are equal for all nozzles serving as the adjustment targets. Further, in step S210, for example, confirmation on completion of adjustment may be performed by the user confirming whether there are problems in the results displayed by the image analysis tool. Then, in step S210, if it is determined that adjustment has not been completed, the process returns to step S206 and repeats the subsequent operations. With such a configuration, the correction value for adjusting the quantity of the ink can be calculated with higher accuracy. In addition, if it is determined in step S210 that adjustment has not been completed, correction may be performed such that correct adjustment results are obtained. Further, if it is determined in step S210 that adjustment has been completed, the operation in step S106 is ended and the process proceeds to step S108. In step S108, the image analysis device 16 outputs correction value data and an analysis result file based on the correction value calculated in the operations described above.

In step S108, the image analysis device 16 or the printing control unit 18 is configured to adjust the voltage of the drive signal supplied to the inkjet head 202 based on the difference in the ink landing position described above by reflecting the correction value calculated in step S106 to the database 20. Further, in this case, by reflecting the correction value for each nozzle to the database 20 for the drive signal of each nozzle, adjustment to the voltage is performed based on the deviation amount of each nozzle. With such a configuration, adjustment to the drive signal for each nozzle can be appropriately performed. Therefore, according to the present embodiment, regarding the quantity of the ink ejected from the nozzles of the inkjet head 202, the status of the printing apparatus 12 can be appropriately detected based on the difference in the ink landing position in the main scanning direction detected using the adjustment pattern. Moreover, based on the detected results, adjustment to the printing apparatus 12 can be appropriately performed.

Further, as can be understood from the above description and the like, the adjustment pattern used in the present embodiment is an example of a pattern obtained by causing the inkjet head 202 to eject to the ink from heights different from each other. In addition, in the operation of step S106, difference in the ink landing position in the main scanning direction is detected by measuring the distance in the main scanning direction for two ink dots formed by landing of the ink ejected from two heights different from each other. Further, the operation performed in step S108 based on the result calculated in step S106 may be considered as an operation of performing adjustment based on the difference in the ink landing position. Moreover, the operation of step S108 may also be considered as an operation of performing adjustment of changing the quantity of the ink ejected from the nozzle based on the result of analysis in step S106.

Subsequently, supplementary descriptions related to the configurations described above, as well as descriptions of modified examples, will be provided. As can be understood from the above description, in the present embodiment, the image analysis device 16 is configured to calculate the correction value according to Calculation Formulas 1 and 2 described above. The correction value is a value calculated based on the result of comparing the measured difference ΔLm in the flight distance with the target distance ΔL. Further, as described above, the measured difference ΔLm in the flight distance corresponds to the positional shift in the main scanning direction between the first pattern 412 and the second pattern 414 in the gap variation pattern 410 included in the adjustment pattern. Then, the target distance ΔL corresponds to a predetermined reference distance. Therefore, the correction value calculated in step S106 is a value corresponding to the result of comparing such a reference value with the difference. Moreover, this reference value is a deviation value that should be detected in the case where the quantity of the ink is appropriate. In addition, such a deviation value may also be considered as a distance corresponding to the case where the quantity of the ink is appropriate, regarding the distance between a reference position of the first pattern 412 and a reference position of the second pattern 414. Further, the operation of step S108 may also be considered as an operation of performing adjustment to the printing apparatus 12 by reflecting the adjustment value or the correction value, which are calculated corresponding to the target distance to the control on the printing apparatus 12.

In addition, as described above, in the present embodiment, the image analysis device 16 is configured to calculate the correction value and the like based on the pattern image generated by reading the adjustment pattern with the scanner 14. Therefore, according to the present embodiment, the voltage of the drive signal can be adjusted even in the case where the printing apparatus 12 does not include a camera or a colorimeter for performing reading on the printing result. Further, as described above, an inexpensive scanner for PC or the like may be used as the scanner 14. Accordingly, adjustment to the voltage of the drive signal and the like can be appropriately performed directly in the environment in which the printing apparatus 12 is used, for example, not only in the factory where the printing apparatus 12 is manufactured, but also at the site where the printing apparatus 12 is used. Further, this make it possible to easily and appropriately perform adjustment to the printing apparatus 12 even when deviation occurs in the quantity of the ink due to aging deterioration or the like of the printing apparatus 12.

In addition, as described above, in the printing system 10 of the present embodiment, adjustment to the voltage of the drive signal is performed as adjustment to the printing apparatus 12. By changing the voltage of the drive signal, the quantity of the ink ejected from the nozzle of the inkjet head 202 is changed. This is based on the observation that there is a predetermined relationship between the quantity of the ejected ink and the ejection direction velocity. That is, this is based on the observation that there is a monotonically increasing relationship between the quantity of the ink and the effective ejection direction velocity of the ink during flight.

Further, during measurement of the difference ΔLm in the flight distance, the difference for varying the head gap is desirably configured to be about 1 mm (0.5 to 2 mm). More specifically, the head gap may be changed between two distances of about 1.5 mm and about 2.5 mm to perform measurement of the difference ΔLm in the flight distance. In addition, the target distance is desirably configured to be about 100 μm (about 90 to 140 μm). It is desirable that the voltage of the drive signal be set such that a range of voltage changed with respect to a standard voltage is approximately −3 V to +3 V. Moreover, by changing the voltage of the drive signal by 1 V, the difference ΔLm in the flight distance may change by about 10 to 50 μm (preferably about 15 to 40 μm). This difference corresponds to the parameter A in Calculation Formula 1 described above.

Further, in the case where the adjustment pattern including the gap variation pattern 410 is used, adjustments other than the voltage of the drive signal may also be performed based on the measured difference ΔLm in the flight distance. As described above, in the case where the difference ΔLm in the flight distance corresponding to any nozzle differs from the target distance ΔL, the quantity of the ink ejected from the nozzle is not at an appropriate quantity. Then, in such a case, for example, in a processing of generating a printing image (printing data) supplied to the printing apparatus 12 as an image to be printed, image processing may be performed considering the difference between the difference ΔLm in the flight distance and the target distance ΔL. Further, in such a case, for example, in a RIP processing executed during generation of the printing image or a pre-processing thereof, correction may be performed based on the difference between the difference ΔLm in the flight distance and the target distance ΔL. More specifically, when the difference ΔLm in the flight distance corresponding to any nozzle differs from the target distance ΔL, with a deviation occurring in the position and the size of the ink dots formed on the medium, a deterioration (for example, a change in the color tone in a part of the image) may occur in the image quality of the image to be printed. It is considered that this difference may be fed back to the processing of generating the printing image in order to reduce such deterioration. With such a configuration, the quantity of the ink ejected to each position of the image may be controlled to perform color correction. With such a configuration as well, adjustment to the printing apparatus 12 can be appropriately performed.

Further, as described above, the flight distance of the ink between the inkjet head 202 and the medium varies according to the head gap. Then, when the height of the inkjet head 202 is the same, the head gap is configured to be changed according to the thickness of the medium. As a result, the difference the ink landing position in the main scanning direction measured as the difference ΔLm in the flight distance also changes according to the thickness of the medium. In such a case, for example, the thickness of the medium may also be detected based on the difference in the ink landing position in the main scanning direction. More specifically, data representing the relationship between the difference ΔLm in the flight distance and the head gap in the case of the appropriate quantity of the ink may be prepared in advance. Further, the height of the inkjet head 202 is set to a predetermined known height, and the difference ΔLm in the flight distance is measured using nozzles having the appropriate quantity of the ink. Then, based on the data described above, the head gap corresponding to the measured difference ΔLm in the flight distance is obtained. Moreover, the thickness of the medium is calculated based on the obtained head gap and the height of the inkjet head 202. In addition, with such a configuration, the thickness of the medium can be detected in the case where the thickness of the medium is unknown. Further, adjustment to the printing apparatus 12 may also be performed based on the detected thickness of the medium. More specifically, as the adjustment based on the thickness of the medium, adjustment to the height of the inkjet head 202 and the like may be performed.

In addition, when the gap variation pattern 410 including the first pattern 412 and the second pattern 414 is used, matters other than the difference ΔL in the flight distance may also be detected. More specifically, when the gap variation pattern 410 is used, it is possible to detect not only the difference ΔL in the flight distance, but also a change in the manner of landing of the ink caused by variation in the head gap. As the analysis performed based on the gap variation pattern 410, for example, it is also considerable to further detect at least one of the ink misting and curved flight of the ink droplets caused by the ink ejected from the inkjet head 202, based on the first pattern 412 and the second pattern 414 in the gap variation pattern 410. With such a configuration, more diverse information can be obtained based on single test pattern.

Further, in the printing system 10 and the printing apparatus 12, various other modifications may be made in other aspects as well. In the above description, configurations and operations using the scanner 14 have been primarily described to read the adjustment pattern printed on the medium by the printing apparatus 12. Accordingly, reading of the adjustment pattern can be performed easily and appropriately without providing the printing apparatus 12 with a predetermined configuration for reading images. Moreover, it also becomes possible to use a commercially available, inexpensive scanner for PC or the like. However, in a modified example of the printing system 10, reading of the adjustment pattern may also be performed using an image reading device other than the scanner 14. In the case of using the printing apparatus 12 that includes a configuration for reading images, reading of the adjustment pattern may also be performed with this configuration. Further, depending on the accuracy required for adjustment, reading of the adjustment pattern may also be performed using a digital camera or a camera function of a smartphone.

In addition, as described above, in the present embodiment, the printing apparatus 12 is an inkjet printer. The printing apparatus 12 is an example of a configuration that draws two-dimensional (2D) images by ejecting an ink onto a medium. In a modified example of the printing apparatus 12, for example, a 3D printer (3D printing apparatus) that forms three-dimensional shaped objects may also be used as the printing apparatus 12. In such a case, the printing apparatus 12 may be caused to perform an operation of forming two-dimensional images on a medium using a medium that serves as the printing target only in the case of performing adjustment to the printing apparatus 12. With such a configuration as well, adjustment to the printing apparatus 12 can be performed appropriately.

### Industrial Applicability

The present invention may be suitably utilized, for example, in an adjustment method for an inkjet printer.

1. An adjustment method for an inkjet printer comprising:
a pattern printing step of causing the inkjet printer to print a predetermined test pattern on a medium;
an analysis step of performing analysis on a result of reading the test pattern printed on the medium; and
an adjustment step of performing adjustment of reflecting a result of the analysis in the analysis step to an operation of the inkjet printer, wherein
the inkjet printer comprises:
an inkjet head that ejects an ink;
a main scanning drive unit that causes the inkjet head to perform a main scanning operation of ejecting the ink while moving in a main scanning direction orthogonal to a vertical direction; and
a head position adjustment unit that changes a height of the inkjet head in the vertical direction,
in the pattern printing step, by varying the height of the inkjet head in a plurality of levels with the head position adjustment unit, a head gap, which is a distance between a surface of the medium and a nozzle surface at a lower part of the inkjet head, is varied in a plurality of levels, and the inkjet printer is caused to print the test pattern,
in the analysis step, a difference in an ink landing position in the main scanning direction that occurs due to a variation in the head gap is detected based on the test pattern, and
in the adjustment step, adjustment based on the difference in the ink landing position is performed.

2. The adjustment method for an inkjet printer according to claim 1, further comprising:
a pattern reading step of generating a pattern image, which is an image representing the test pattern, by reading the medium on which the test pattern is printed in the pattern printing step with a scanner,
wherein, in the analysis step, analysis of a reading result of the test pattern is performed by analyzing the pattern image representing the test pattern using a computer.

3. The adjustment method for an inkjet printer according to claim 1, wherein
the inkjet printer further comprises a sub-scanning drive unit that moves the inkjet head relatively with respect to the medium in a sub-scanning direction orthogonal to the main scanning direction and the vertical direction,
the test pattern comprises a gap variation pattern, which is a pattern formed by varying the head gap in a plurality of levels,
the gap variation pattern comprises:
a first pattern formed with the ink ejected by the inkjet head at a timing at which the inkjet head moving in the main scanning operation reaches a predetermined position in the main scanning direction, with the head gap configured to be a first height; and
a second pattern, which is a pattern formed by shifting a position in the sub-scanning direction from the first pattern, and is formed with the ink ejected by the inkjet head at a timing at which the inkjet head moving in the main scanning operation reaches the predetermined position, with the head gap configured to be a second height different from the first height,
in the analysis step, a positional shift of the first pattern and the second pattern in the main scanning direction is detected, and
in the adjustment step, the adjustment is performed based on the positional shift.

4. The adjustment method for an inkjet printer according to claim 3, wherein
in the analysis step, at least one of the ink misting and curved flight of the ink droplets caused by the ink ejected from the inkjet head is further detected based on the first pattern and the second pattern.

5. The adjustment method for an inkjet printer according to claim 1, wherein
the inkjet printer further comprises a drive signal output unit that outputs a drive signal for driving the inkjet head, and
in the adjustment step, a voltage of the drive signal supplied to the inkjet head is adjusted based on the difference in the ink landing position.

6. The adjustment method for an inkjet printer according to claim 5, wherein
the inkjet printer further comprises a sub-scanning drive unit that moves the inkjet head relatively with respect to the medium in a sub-scanning direction orthogonal to the main scanning direction and the vertical direction,
the test pattern comprises a gap variation pattern, which is a pattern formed by varying the head gap in a plurality of levels,
the gap variation pattern comprises:
a first pattern formed with the ink ejected by the inkjet head at a timing at which the inkjet head moving in the main scanning operation reaches a predetermined position in the main scanning direction, with the head gap configured to be a first height; and
a second pattern, which is a pattern formed by shifting a position in the sub-scanning direction from the first pattern, and is formed with the ink ejected by the inkjet head at a timing at which the inkjet head moving in the main scanning operation reaches the predetermined position, with the head gap configured to be a second height different from the first height,
in the analysis step, a positional shift of the first pattern and the second pattern in the main scanning direction is detected, and
in the adjustment step, the voltage of the drive signal is changed according to a result of comparing a reference value set in advance with the positional shift.

7. The adjustment method for an inkjet printer according to claim 6, wherein
the inkjet head has a plurality of nozzles,
the drive signal output unit supplies the drive signal to the inkjet head for each of the nozzles,
the gap variation pattern comprises the first pattern and the second pattern enabling detecting the positional shift of each of the nozzles,
in the analysis step, the positional shift is detected for each of the nozzles, and
in the adjustment step, adjustment to the voltage of the drive signal is performed for the drive signal of each of the nozzles based on the positional shift of each of the nozzles.

8. The adjustment method for an inkjet printer according to claim 1, wherein
in the adjustment step, the adjustment is performed based on the difference in the ink landing position by executing image processing on a printing image supplied to the inkjet printer as an image to be printed based on the difference in the ink landing position.

9. The adjustment method for an inkjet printer according to claim 1, wherein
in the analysis step, a thickness of the medium is detected based on the difference in the ink landing position, and
in the adjustment step, the adjustment is performed based on the thickness of the medium.

10. A non-transitory computer-readable recording medium recording a program causing a computer to perform image analysis,
the program causing the computer to perform analysis processing on a reading result of a predetermined test pattern printed on a medium by an inkjet printer, wherein
the inkjet printer comprises:
an inkjet head that ejects an ink;
a main scanning drive unit that causes the inkjet head to perform a main scanning operation of ejecting the ink while moving in a main scanning direction orthogonal to a vertical direction; and
a head position adjustment unit that changes a height of the inkjet head in the vertical direction,
the test pattern is a pattern printed by the inkjet printer upon varying the height of the inkjet head in a plurality of levels by the head position adjustment unit to vary a head gap, which is a distance between a surface of the medium and a nozzle surface at a lower part of the inkjet head, in a plurality of levels, and
in the analysis processing, the computer is caused to:
detect, based on the test pattern, a difference in an ink landing position in the main scanning direction that occurs due to a variation in the head gap, and
calculate a correction value to be used for adjustment to the inkjet printer based on the difference in the ink landing position.

11. The non-transitory computer-readable recording medium according to claim 10, wherein
in the analysis processing, by causing the computer to perform analysis on a pattern image, which is an image generated by reading the medium on which the test pattern is printed with a scanner, the difference in the ink landing position is detected based on the pattern image.

12. A printing system performing printing according to an inkjet method, comprising:
an inkjet printer that performs printing according to the inkjet method; and
an analysis device that performs analysis processing on a result of reading a predetermined test pattern printed on a medium by the inkjet printer, wherein
the inkjet printer comprises:
an inkjet head that ejects an ink;
a main scanning drive unit that causes the inkjet head to perform a main scanning operation of ejecting the ink while moving in a main scanning direction orthogonal to a vertical direction; and
a head position adjustment unit that changes a height of the inkjet head in the vertical direction,
the test pattern is a pattern printed by the inkjet printer upon varying the height of the inkjet head in a plurality of levels by the head position adjustment unit to vary a head gap, which is a distance between a surface of the medium and a nozzle surface at a lower part of the inkjet head, in a plurality of levels, and
the analysis device is configured to:
detect, based on the test pattern, a difference in an ink landing position in the main scanning direction that occurs due to a variation e in the head gap, and
calculate a correction value to be used for adjustment to the inkjet printer based on the difference in the ink landing position.

13. The printing system according to claim 12, further comprising:
a scanner that performs reading of an image, wherein
the analysis device detects the difference in the ink landing position based on the pattern image by performing analysis on a pattern image, which is an image generated by reading the medium on which the test pattern is printed with the scanner.

14. The non-transitory computer-readable recording medium according to claim 10, wherein
the inkjet printer further comprises a sub-scanning drive unit that moves the inkjet head relatively with respect to the medium in a sub-scanning direction orthogonal to the main scanning direction and the vertical direction,
the test pattern comprises a gap variation pattern, which is a pattern formed by varying the head gap in a plurality of levels,
the gap variation pattern comprises:
a first pattern formed with the ink ejected by the inkjet head at a timing at which the inkjet head moving in the main scanning operation reaches a predetermined position in the main scanning direction, with the head gap configured to be a first height; and
a second pattern, which is a pattern formed by shifting a position in the sub-scanning direction from the first pattern, and is formed with the ink ejected by the inkjet head at a timing at which the inkjet head moving in the main scanning operation reaches the predetermined position, with the head gap configured to be a second height different from the first height,
in the analysis processing, the computer is caused to:
detect a positional shift of the first pattern and the second pattern in the main scanning direction, and
calculate the correction value to be used for the adjustment based on the positional shift.

15. The non-transitory computer-readable recording medium according to claim 14, wherein
in the analysis processing, the computer is caused to:
detect at least one of the ink misting and curved flight of the ink droplets caused by the ink ejected from the inkjet head based on the first pattern and the second pattern.

16. The non-transitory computer-readable recording medium according to claim 10, wherein
the inkjet printer further comprises a drive signal output unit that outputs a drive signal for driving the inkjet head, and
in the analysis processing, the computer is caused to:
adjust a voltage of the drive signal supplied to the inkjet head based on the difference in the ink landing position.

17. The non-transitory computer-readable recording medium according to claim 16, wherein
the inkjet printer further comprises a sub-scanning drive unit that moves the inkjet head relatively with respect to the medium in a sub-scanning direction orthogonal to the main scanning direction and the vertical direction,
the test pattern comprises a gap variation pattern, which is a pattern formed by varying the head gap in a plurality of levels,
the gap variation pattern comprises:
a first pattern formed with the ink ejected by the inkjet head at a timing at which the inkjet head moving in the main scanning operation reaches a predetermined position in the main scanning direction, with the head gap configured to be a first height; and
a second pattern, which is a pattern formed by shifting a position in the sub-scanning direction from the first pattern, and is formed with the ink ejected by the inkjet head at a timing at which the inkjet head moving in the main scanning operation reaches the predetermined position, with the head gap configured to be a second height different from the first height,
in the analysis processing, the computer is caused to:
detect a positional shift of the first pattern and the second pattern in the main scanning direction, and
calculate the correction value to be used for changing the voltage of the drive signal according to a result of comparing a reference value set in advance with the positional shift.

18. The non-transitory computer-readable recording medium according to claim 17, wherein
the inkjet head has a plurality of nozzles,
the drive signal output unit supplies the drive signal to the inkjet head for each of the nozzles,
the gap variation pattern comprises the first pattern and the second pattern enabling detecting the positional shift of each of the nozzles,
in the analysis processing, the computer is caused to:
detect the positional shift for each of the nozzles, and
calculate the correction value to be used for adjustment to the voltage of the drive signal for the drive signal of each of the nozzles based on the positional shift of each of the nozzles.

19. The non-transitory computer-readable recording medium according to claim 10, wherein
in the analysis processing, the computer is caused to:
detect a thickness of the medium based on the difference in the ink landing position, and
calculate the correction value to be used for the adjustment based on the thickness of the medium.

20. The printing system according to claim 12, wherein the analysis device is a computer.
